(19) United States
(12) Patent Application Publication
(10) Pub. No.: US 2024/0005908 A1
(43) Pub. Date: Jan. 4, 2024

(54) ACOUSTIC ENVIRONMENT PROFILE ESTIMATION

(71) Applicant: Nuance Communications, Inc., Burlington, MA (US)

(72) Inventors: Dushyant SHARMA, Mountain House, CA (US); Patrick Aubrey NAYLOR, Reading (GB); Ge LI, Montreal (CA)

(21) Appl. No.: 18/058,266

(22) Filed: Nov. 22, 2022

Related U.S. Application Data
(60) Provisional application No. 63/357,023, filed on Jun. 30, 2022.

(51) Int. Cl. G10L 15/02; G10L 25/18

(52) U.S. Cl. CPC G10L 15/02; G10L 25/18

(57) ABSTRACT

An acoustic environment profile estimation is provided for automatic speech recognition (ASR) to compensate for the acoustic behavior of an environment in which audio is collected. Examples receive an audio signal and extract spectral features and modulation features. Extracting spectral features involves determining Mel filter bank (MFB) coefficients, and extracting modulation features involves applying Fourier transforms. The spectral features and modulation features are combined, and an acoustic environment profile estimate is extracted and provided as an input to the ASR. In some examples, the acoustic environment profile estimate is realized as acoustic environment parameters, whereas in some other examples, the acoustic environment profile estimate is realized as an acoustic embedding vector. For versions using acoustic environment parameters, when the acoustic environment changes significantly, such as flooring changes and/or speakers or microphones changing position, a new set of acoustic environment parameters is determined.

### CROSS REFERENCE TO RELATED APPLICATIONS

This application claims the benefit of U.S. Provisional Patent Application Ser. No. 63/357,023 filed on Jun. 30, 2022 and entitled “Acoustic Environment Neural Embedding System”, which is hereby incorporated by reference in its entirety for all intents and purposes.

### BACKGROUND

In real world speech processing applications, clean speech may be corrupted by multiple factors including room reverberation, additive noise, and coding artifacts, which degrade the quality and intelligibility of the signal. The estimation of parameters characterizing these corrupting factors, as well as the perceived quality and intelligibility of the speech, has important implications for automatic speech recognition (ASR), audio forensics, text-to-speech and speaker diarization (which partitions audio segments or transcripts by speaker identity). Common solutions for estimating the parameters use intrusive signal analysis (ISA). However, in real world deployments, the clean speech reference signal required by ISA methods may not be available.

### SUMMARY

The disclosed examples are described in detail below with reference to the accompanying drawing figures listed below. The following summary is provided to illustrate some examples disclosed herein. It is not meant, however, to limit all examples to any particular configuration or sequence of operations.

Example solutions for acoustic environment profile estimation include: receiving a first audio signal containing speech; extracting a first set of spectral features and a first set of modulation features from the first audio signal; combining the first sets of spectral features and modulation features into a first combined feature set; extracting a first acoustic environment profile estimate from the first combined feature set; and performing automatic speech recognition (ASR) using the first acoustic environment profile estimate.

### BRIEF DESCRIPTION OF THE DRAWINGS

The disclosed examples are described in detail below with reference to the accompanying drawing figures listed below:

FIG. 1 illustrates an example architecture that advantageously performs and leverages acoustic environment profile estimation;

FIGS. 2A-2D illustrate an example implementation variation of an architecture, such as the architecture of FIG. 1;

FIG. 3 illustrates another example implementation variation of an architecture, such as the architecture of FIG. 1;

FIG. 4 illustrates exemplary spectral and feature extraction in an architecture, such as the architecture of FIG. 1;

FIGS. 5A and 5B illustrate example implementation variations for the concatenation in an architecture, such as the architecture of FIG. 1;

FIG. 6 shows a flowchart illustrating exemplary operations that may be performed, such as in examples of the architecture of FIG. 1;

FIG. 7 shows another flowchart illustrating exemplary operations that may be performed, such as in examples of the architecture of FIG. 1;

FIG. 8 shows another flowchart illustrating exemplary operations that may be performed, such as in examples of the architecture of FIG. 1; and

FIG. 9 shows a block diagram of an example computing device suitable for implementing some of the various examples disclosed herein.

Corresponding reference characters indicate corresponding parts throughout the drawings. Any of the figures may be combined into a single example or embodiment.

### DETAILED DESCRIPTION

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

A speech signal acquired in real world conditions is typically affected by unwanted and sometimes unavoidable artifacts. The unwanted artifacts include background noise and room reverberation. The unavoidable artifacts arise from the need to compress and transmit a signal over limited bandwidth using audio codecs, for example.

The process of room reverberation may be modeled as a convolution between anechoic speech and a room impulse response (RIR). The effects of reverberation have typically been characterized by the following intrusive parameters (extracted from an RIR): reverberation time (T60), clarity index (C50) and direct-to-reverberant energy ratio (DRR). In addition, a number of parameters can be defined for the simulation of RIRs, including room volume and reflection coefficients for reflective surfaces in a room.

In contrast, non-intrusive signal analysis (NISA) does not require a clean speech reference signal. Thus, a NISA solution has greater applicability, for example a deployment in office environments. Estimation of perceived speech quality using NISA is a challenging task due to its subjective nature. Non-intrusive methods typically estimate speech quality parameters, room acoustics, and codec parameters individually. Speech is often encoded via a codec to reduce transmission bandwidth.

The present disclosure provides acoustic environment profile estimation for accurate automatic speech recognition (ASR) to compensate for the acoustic behavior of an environment in which audio is collected. Examples receive an audio signal and extract spectral features and modulation features. Extracting spectral features involves determining Mel filter bank (MFB) coefficients, and extracting modulation features involves applying Fourier transforms. The spectral features and modulation features are combined, and an acoustic environment profile estimate is extracted and, in some examples, provided as an input to the ASR. In some examples, the acoustic environment profile estimate is realized as acoustic environment parameters, whereas in some other examples, the acoustic environment profile estimate is realized as an acoustic embedding vector. For some versions using acoustic environment parameters, when the acoustic environment changes significantly, such as flooring changes and/or speakers or microphones changing position, a new set of acoustic environment parameters is determined.

Aspects of the disclosure enhance the accuracy and reduce the error rate of ASR by performing ASR using an acoustic environment profile estimate. This benefits user interaction at least by providing more reliable and useful ASR results to users more quickly. Some examples use the acoustic environment profile estimate for training an ASR model, further enhancing the accuracy and reducing the error rate of ASR. Aspects of the disclosure may be deployed on a mobile device, a tablet, a conference room system, and other computing devices, and may be used for use for transcription, voice biometrics, and voice controls of computing and other devices.

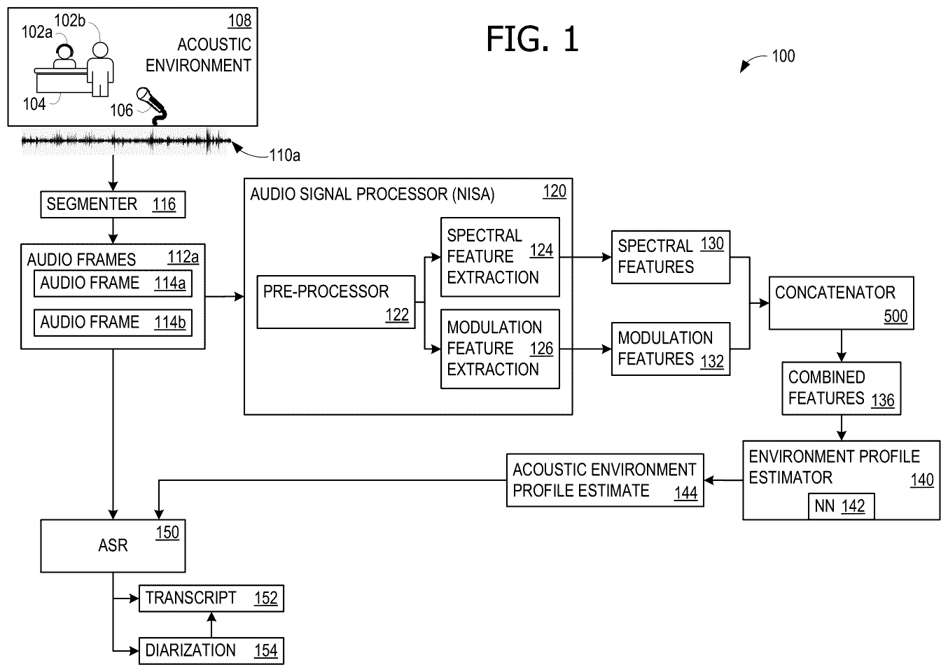

FIG. 1 illustrates an example architecture 100 that advantageously performs and leverages acoustic environment profile estimation. In FIG. 1, speech is being captured in an acoustic environment 108. Acoustic environment 108 may be, for example, a doctor's office and the purpose of capturing the speech is to produce a transcript 152 of a patient, speaker 102b, speaking with a doctor, speaker 102a. In this example, transcript 152 is reviewed at a later time by the doctor or another doctor providing a second opinion, or entered into the patient's medical history. Other types of and uses for transcripts are also contemplated. Portions of architecture 100 may be implemented locally or in a cloud environment. For example, ASR and other components described below that use a neural network (NN) are implemented in a cloud environment, based on the size of the NN and computational power required.

Acoustic environment 108 has objects, such as an object 104 shown as a desk, and also has other objects such as flooring, wall coverings, and other items. These objects may reflect or absorb sound and affect the quality and intelligibility of the speech reaching an audio capture device, such as a headset, a mobile phone, a smart speaker, or other device, that has a microphone 106 that captures an audio signal 110a. Other characteristics of acoustic environment 108 include distances between microphone 106 and each of speakers 102a and 102b. ASR is accurate when the characteristics of acoustic environment 108 are taken into account when performing the ASR process, as described herein.

Audio signal 110a is segmented by audio segmenter 116 into a plurality of audio frames 112a. Plurality of audio frames 112a has multiple overlapping audio frames, such as audio frame 114a and audio frame 114b. Plurality of audio frames 112a represents audio signal 110a containing speech from speakers 102a and 102b, although broken into frames that are suitable for consumption by an ASR model 150 and an audio signal processor 120. In some examples, the audio frames are each 10 milliseconds (ms) to 20 ms with a 5 ms time increment.

Audio signal processor 120 performs NISA, including receiving audio signal 110a as plurality of audio frames 112a, and extracting spectral features 130 and modulation features 132.

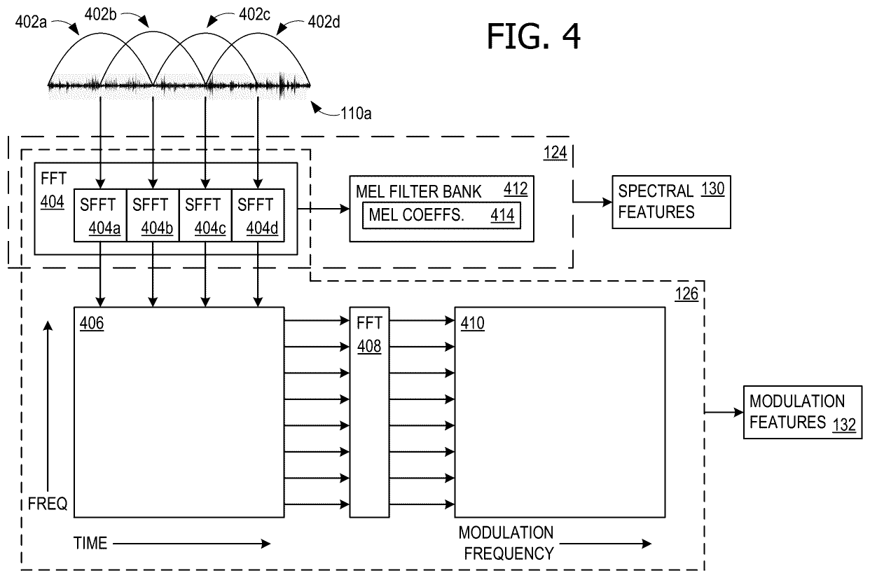

Audio signal processor 120 has a pre-processor 122 which filters audio signal 110a, for example, to perform automatic gain control, increase the count of the audio frames with a window function (e.g., a Hanning window), and provide other functionality. A spectral feature extraction arrangement 124 extracts spectral features 130 from audio signal processor 120 after it has been output from pre-processor 122. A modulation feature extraction arrangement 126 extracts modulation features 132 from audio signal processor 120 after it has been output from pre-processor 122. Spectral feature extraction arrangement 124 and modulation feature extraction arrangement 126 are shown in further detail in FIG. 4.

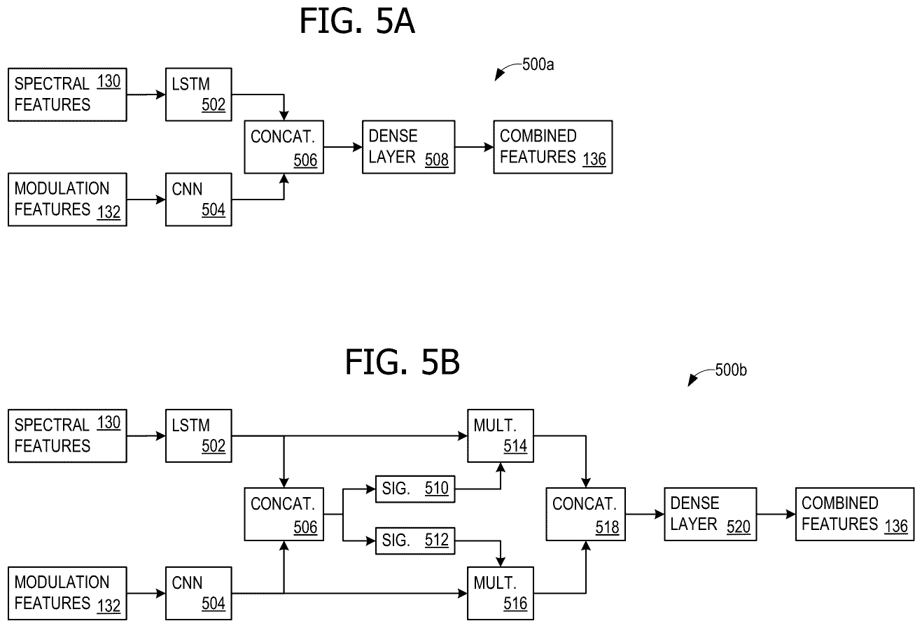

A concatenator 500 combines spectral features 130 and modulation features 132 into a combined feature set 136. The combination of spectral and modulation features permits estimation of a large number of acoustic parameters from a single channel signal. Further detail regarding two optional implementations of concatenator 500 is shown in FIGS. 5A and 5B.

An environmental profile estimator 140 extracts an acoustic environment profile estimate 144 from combined feature set 136. Environmental profile estimator 140 comprises an NN 142. In some examples, NN 142 comprises a deep NN (DNN). Other NN architecture types used in NN 142, concatenator 500, spectral feature extraction arrangement 124, and/or ASR model 150 include a recurrent NN (RNN), a long-term short-term memory (LSTM) network, and a convolutional NN (CNN).

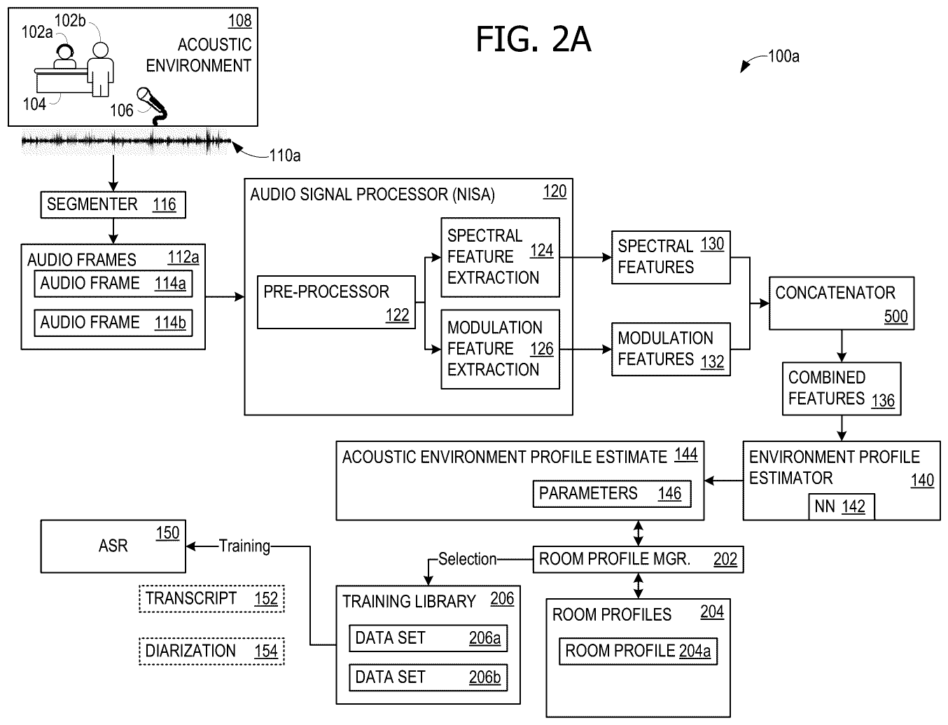

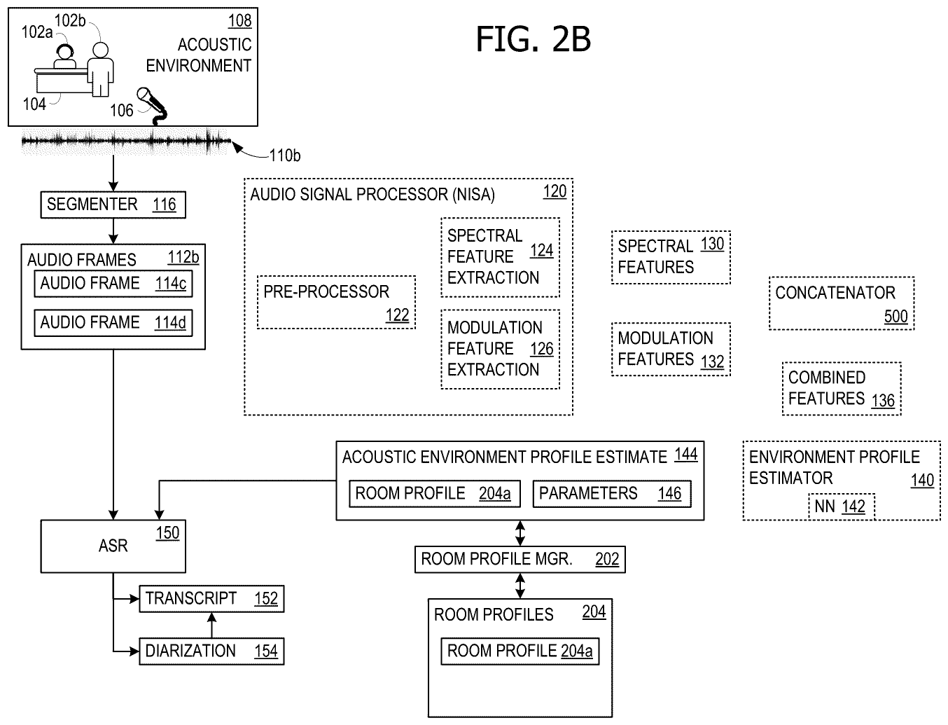

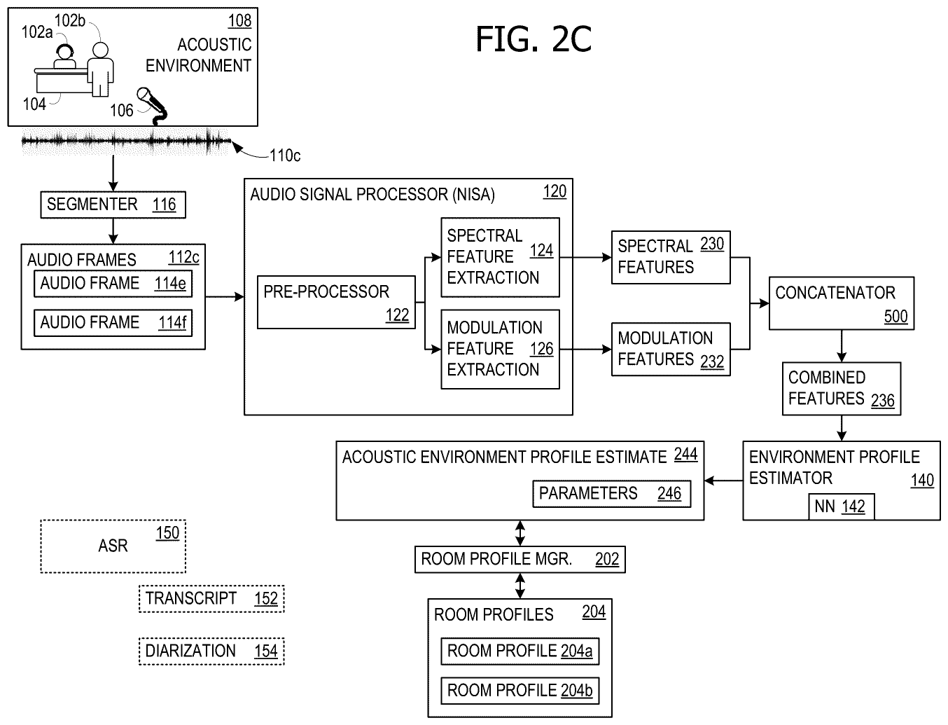

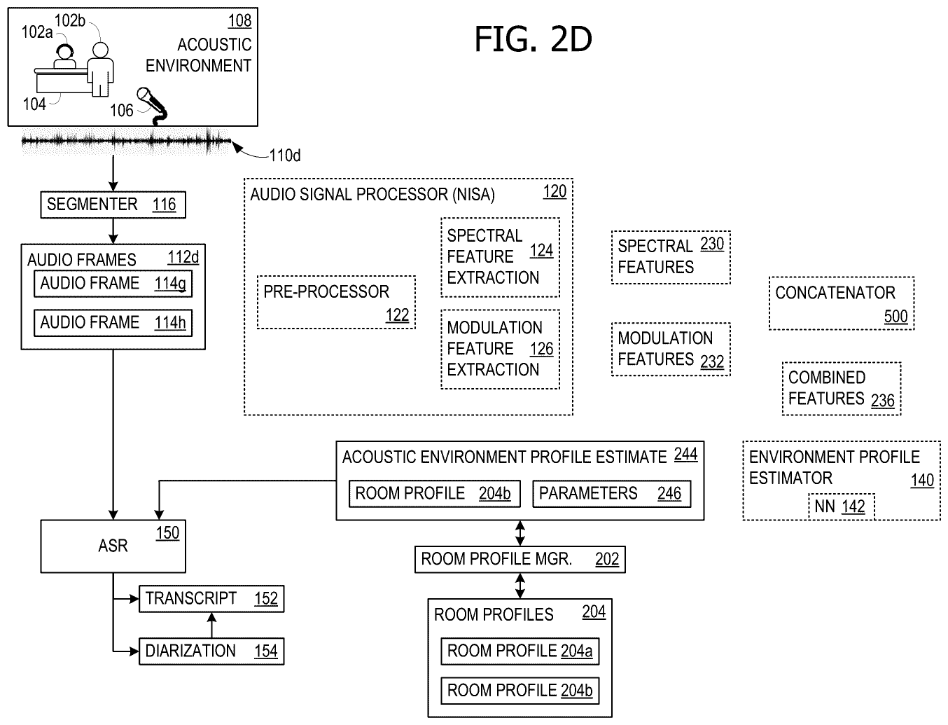

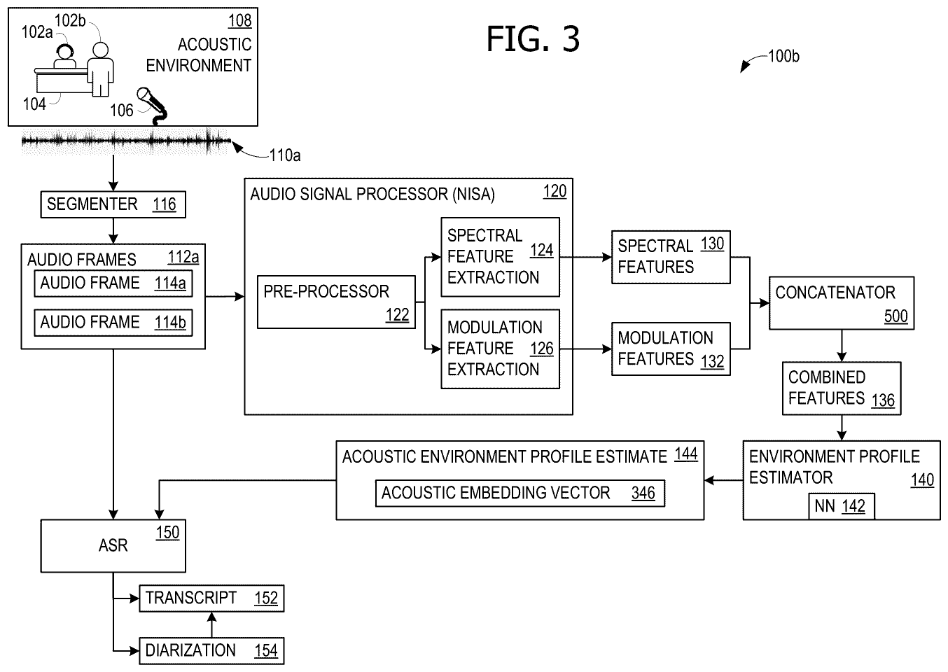

Acoustic environment profile estimate 144 may take on multiple different forms, as shown in FIGS. 2A and 3, including a plurality of acoustic environment parameters, an environment profile, and/or an acoustic embedding vector. The configuration of architecture 100 in which acoustic environment profile estimate 144 takes the form of acoustic environment parameters and an environment profile is architecture 100a, shown in FIG. 2A, and configuration of architecture 100 in which acoustic environment profile estimate 144 takes the form of an acoustic embedding vector is architecture 100b, shown in FIG. 3.

ASR model 150 performs ASR using acoustic environment profile estimate 144, and generates transcript 152, provides speaker diarization 154 (which may be used to segment transcript 152 by speaker), and/or performs other tasks, such as providing voice control.

FIGS. 2A-2D illustrate architecture 100a, in which acoustic environment profile estimate 144 is manifest as a plurality of acoustic environment parameters 146 and also an environment profile. For convenience, the environment profile is also referred to herein as a room profile. However, aspects of the disclosure are not limited to the profile of a room, but rather are operable with any environment (e.g., closed, open, indoor, outdoor, etc.). For example, aspects of the disclosure address aspects of the transmission channel, such as the presence of a speech codec (e.g., the Opus audio codec), the bit rate of the codec, and others.

A wide variety of parameters may be used, including signal to noise ratio (SNR), segmental SNR (SSNR), noise type, clarity index (C50), room impulse response (RIR), reverberation time (T60), direct-to-reverberant energy ratio (DRR), room volume, reflection coefficients, voice activity, codec information, bit rate, speech quality, short-time objective intelligibility (STOI), and perceptual quality. SSNR uses segments of 10 ms to 20 ms, in some examples. Speech quality estimation may use perceptual evaluation of speech quality (PESQ). Speech intelligibility estimation may use an extended short-time objective intelligibility (ESTOI) algorithm.

In some examples, each parameter is estimated by an individual estimation task worker in the final stages of NN 142. NN 142 may have later stages of dense metrics layers, each followed by an estimation task worker. An example uses seven regression workers (C50, DRR, SSNR, PESQ, ESTOI, VADP and bit rate) and one binary classification worker (codec detection).

A room profile manager 202 intakes plurality of acoustic environment parameters 146 and produces a room profile 204a, which is stored among a plurality of room profiles 204. A user of architecture 100 may generate a room profile for each room in which ASR is to be performed. For example, in a doctor's office, there is a custom room profile for each examination room. In operation, the process may be that an hour of conversation is collected in a room (e.g., acoustic environment 108) and provided to audio signal processor as audio signal 110a. Plurality of acoustic environment parameters 146 is extracted and provided to room profile manager 202 to generate room profile 204a as adaption data (to adapt ASR model 150 to that particular room). This process is repeated for each of the other rooms.

Some examples employ a Voice Activity Detection (VAD) estimation to distinguish between speech and non-speech audio frames. The VAD estimator obtains a label by assigning each audio frame to a binary class and then averaging those labels over a context window of 400 ms to obtain a posterior VAD parameter (VADP) in the range of 0 to 1. Each estimation task is solved by an individual worker comprising of a single fully connected output layer. Some examples use a VADP threshold of 0.5.

When training data-driven speech processing systems, such ASR model 150, it is preferable to simulate or sample, from an existing collection, training data that is representative of the deployment environment for an intended use case. It is helpful to analyze a collection of training data and extract histograms of the most relevant metrics affecting performance, such as reverberation and noise levels, and use these histograms to select a custom-focused training dataset. Thus, room profile manager 202 (or another function) selects a training data set from training library 206 to use for training ASR model 150. Selection from among training data set 206a and training data set 206b within training library 206 is made based on the similarity of the acoustic environment parameters manifest within the training data sets with plurality of acoustic environment parameters 146. Training loss functions may include mean absolute error (MAE), root mean square error (RMSE), word error rate (WER), and/or diarization error rate (DER).

In architecture 100a, audio signal 110a is used for generating room profile 204a and/or selecting training data set 206a. ASR is performed at a later time. FIG. 2B illustrates using acoustic environment profile estimate 144 (as room profile 204a) to perform ASR on a later-captured speech, which is captured as audio signal 110b. Audio signal 110b is segmented into a plurality of audio frames 112b, comprising audio frame 114c and audio frame 114d. Audio signal 110b is provided to ASR model 150 as plurality of audio frames 112b. Room profile 204a is provided as another input to ASR model 150, adapting (e.g., customizing) the performance of ASR model 150 to acoustic environment 108 and thereby benefitting ASR performance.

However, over time, acoustic environment 108 may change. For example, carpet is replaced with floor tiling, wall tiling or cabinets are added or removed, microphone 106 is relocated, or other changes may be made. FIG. 2C illustrates recalibration and production of a new room profile 204b to use as a replacement for room profile 204a.

Audio signal 110c, containing speech, is captured and segmented into a plurality of audio frames 112c, comprising audio frame 114e and audio frame 114f. Audio signal 110c is provided to audio signal processor 120, which extracts new spectral features 230 and new modulation features 232. Concatenator 500 combines these into a new combined feature set 236. Environmental profile estimator 140 extracts an acoustic environment profile estimate 244 from combined feature set 236 as plurality of acoustic environment parameters 246.

Room profile manager 202 compares plurality of acoustic environment parameters 246 with plurality of acoustic environment parameters 146 and determines whether the parameters have changed sufficiently to warrant generating new room profile 204b to replace room profile 204a. If not, room profile 204a remains in use. Otherwise, room profile manager 202 generates room profile 204b and stores it among plurality of room profiles 204.

FIG. 2D illustrates the use of room profile 204b in place of room profile 204a. Audio signal 110d, containing speech, is captured and segmented into a plurality of audio frames 112d, comprising audio frame 114g and audio frame 114h. Audio signal 110d is provided to ASR model 150 as plurality of audio frames 112d. Room profile 204b is provided as another input to ASR model 150, as acoustic environment profile estimate 244, adapting (e.g., customizing) the performance of ASR 150 to the changed acoustic environment 108 and thereby benefitting ASR performance.

FIG. 3 illustrates architecture 100b, in which acoustic environment profile estimate 144 is manifest as an acoustic embedding vector 346. In some examples, acoustic embedding vector 346 is pulled from a late stage of NN 142, prior to the dense metrics layers described above for architecture 100a. In architecture 100b, acoustic embedding vector 346 is provided as an input to ASR model 150, making ASR model 150 environment aware. In architecture 100b, a version of ASR 150 intakes a neural embedding vector rather than a room profile that is based on an acoustic environment profile estimate. Acoustic embedding vector 346 provides a compact representation of a large number of acoustic parameters, and may be used in other applications beyond ASR. In general, acoustic embedding vector 346 is richer than acoustic environment profile estimate 144.

FIG. 4 illustrates an exemplary solution for extracting spectral features 130 and modulation features 132. Window functions 402a-402d segment audio signal 110a into audio frames prior to Fourier transform 404. Audio signal 110a segmented by window function 402a (e.g., audio frame 114a) is provided to a short-time Fourier transform (STFT) 404a. Audio signal 110a segmented by window function 402b (e.g., audio frame 114b) is provided to an STFT 404b. Audio signal 110a segmented by window function 402c is provided to an STFT 404c. Audio signal 110a segmented by window function 402d is provided to an STFT 404d. Other segments are also subjected to STFTs. This produces a spectrogram 406 with k frequency bins and m time frames. In some examples, the number of frequency bins, k, is 256.

The output of Fourier transform 404 is provided to a Mel filter bank (MFB) 412 that obtains Mel coefficients 414. In some examples, this is accomplished by applying multiple triangular filters on a Mel-scale to the power spectrum calculated from Fourier transform 404. In some examples, 80 Mel filters are used. This compacts 256 frequency bins into 80 Mel channels. MFB 412 determines the energy in each sub-band of the output of Fourier transform 404. As indicated, spectral feature extraction arrangement 124 comprises Fourier transform 404 and MFB 412 and outputs spectral features 130.

To extract modulation features 132, modulation feature extraction arrangement 126 comprises Fourier transform 404 and Fourier transform 408. Spectrogram 406 is provided, orthogonally relative to its generation by Fourier transform 404 to Fourier transform 408. This produces a spectrogram 410 with k frequency bins and h modulation bins. Linguistic information is primarily carried in low-frequency modulations of speech. Thus, some examples use a modulation frame size of 400 ms, a modulation step size of 200 m, and a sampling frequency of the modulation signal of 200 Hertz (Hz).

FIGS. 5A and 5B illustrate optional implementation variations for concatenator 500. FIG. 5A shows a direct concatenator 500a, and FIG. 5B shows a gated concatenator 500b. Either may be used as concatenator 500 in architecture 100. In direct concatenator 500a, spectral features 130 is provided to an LSTM 502. An LSTM is an RNN structure designed to capture temporal dependencies in sequential data. In some examples, LSTM 502 has an input layer followed by three hidden layers, arranged in a 108×54×27 cell topology, for each time-step. LSTM 502 extracts an embedding vector X_{MFB}.

Modulation features 132 is provided to a CNN 504 that extracts another embedding vector X_{MS}. CNN architectures have been shown to be effective in the application of Voice Activity Detection (VAD), and so CNN 504 is able to detect the presence of speech. In some examples, CNN 504 includes a plurality of causal gated one-dimensional (1D) convolution with a plurality of filters, a dropout layer; and a flattening operation. The two embedding vectors, X_{MFB} and X_{MS} are concatenated by a concatenation 506 into a concatenated vector X_{Fused_1} that is provided to a dense layer 508 to output combined feature set 136. Concatenated vector X_{Fused_1} is given as:

X_{Fused_1}=[X_{MFB};X_{MS}] Eq. (1)

Gated concatenator 500b also generates concatenated vector X_{Fused_1} so the early stages are carried over. However, rather than sending concatenated vector X_{Fused_1} to a dense layer, it is provided to two sigmoid functions (s-shaped functions on the interval 0,1), a sigmoid 510 and a sigmoid 512. Concatenated vector X_{Fused_1} is used for calculating weightings.

The outputs of sigmoid 510 and LSTM 502 are set to a multiplier 514 for combination, and the outputs of sigmoid 512 and CNN 504 are set to a multiplier 516 for combination. The outputs of multiplier 514 and multiplier 516 are concatenated with a concatenation 518 into a concatenated vector X_{Fused_2} that is provided to a dense layer 520 to output combined feature set 136. Concatenated vector X_{Fused_2} is given as:

ω₁=σ(W₁^{T}X_{Fused_1}+b₁) Eq. (2)

ω₂=σ(W₂^{T}X_{Fused_1}+b₂) Eq. (3)

X_{Fused_2}=[ω₁×X_{MFB};ω₁×X_{MS}] Eq. (4)

where σ is a sigmoid function, b₁ and b₂ are constants, and W₁ and W₂ are learned parameters.

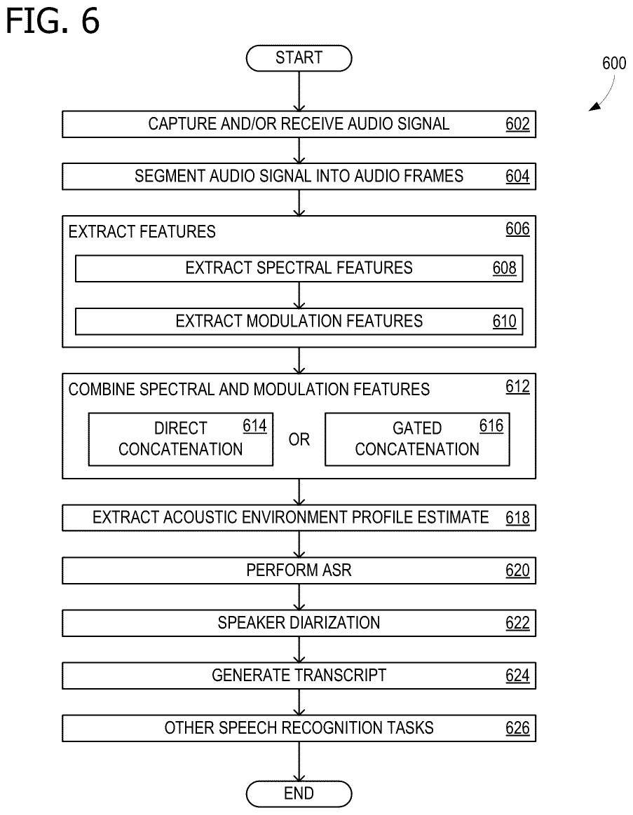

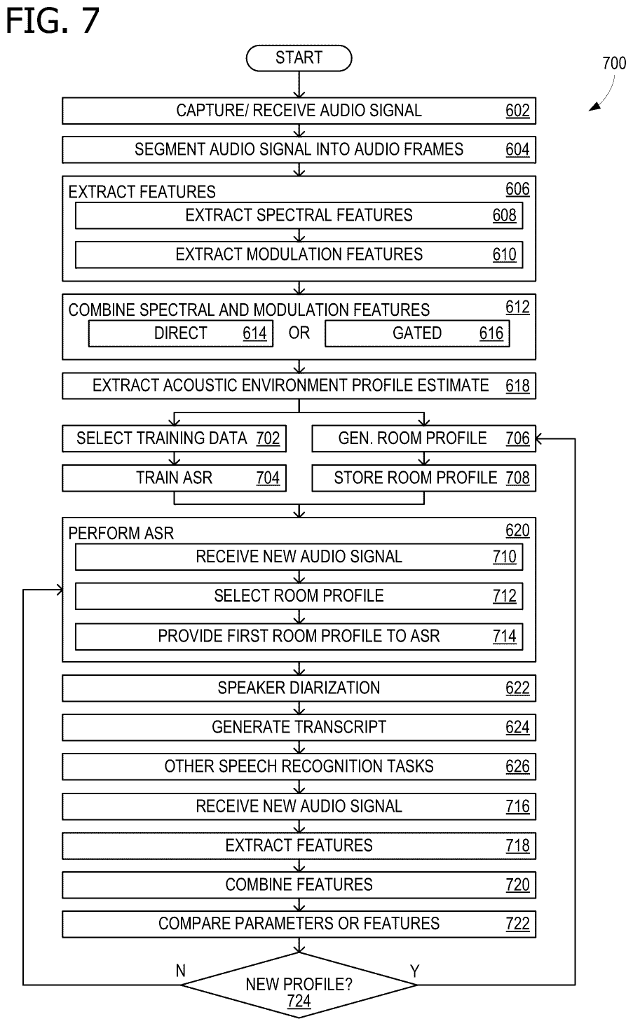

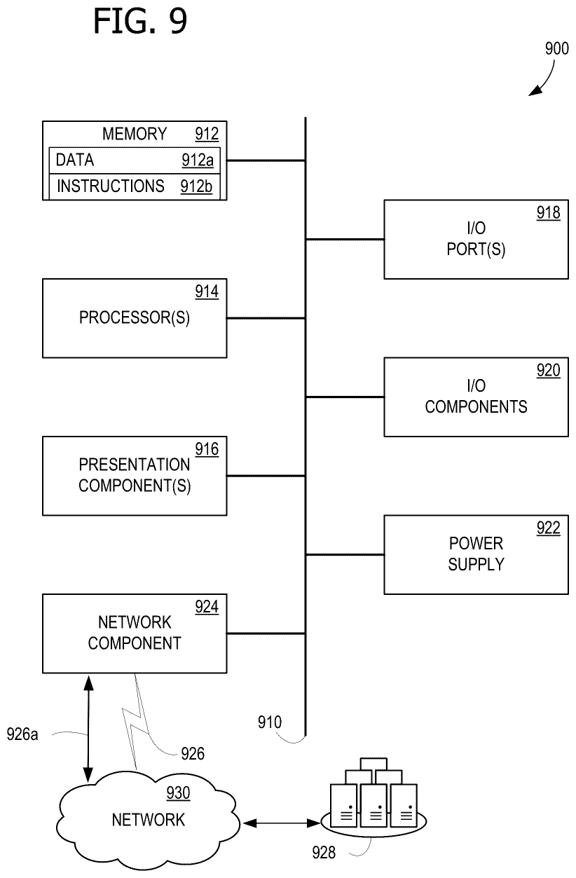

FIG. 6 shows a flowchart 600 illustrating exemplary operations that may be performed by architecture 100, specifically architecture 100b. Architecture 100a is described below in relation to flowchart 700 of FIG. 7. In some examples, operations described for flowcharts 600 and 700 are performed by computing device 900 of FIG. 9. Flowchart 600 commences with capturing an audio signal 110a containing speech, in operation 602. In some examples, audio signal 110 contains a plurality of voice signals from a plurality of speakers. Operation 604 segments audio signal 110a into plurality of audio frames 112a.

Operation 606 extracts a set of spectral features, spectral features 130, and a set of modulation features, modulation features 132, from audio signal 110a using operations 608 and 610. In some examples, this is performed using NISA. Operation 608 determines MFB coefficients from audio signal 110a to extract spectral features 130, and operation 610 applies successive Fourier transforms to audio frames of audio signal 110a to extract modulation features 132. Operation 612 combines spectral features 130 and modulation features 132 into combined feature set 136 using operation 614 or 616. Operation 614 performs direct concatenation using direct concatenator 500a; operation 616 performs gated concatenation using gated concatenator 500b.

Operation 618 extracts acoustic environment profile estimate 144 from combined feature set 136. With architecture 100b, acoustic environment profile estimate 144 comprises acoustic embedding vector 346. Operation 620 performs ASR on audio signal 110a using acoustic environment profile estimate 144 as an input, in the form of acoustic embedding vector 346 in architecture 100b. Operation 622 performs speaker diarization, operation 624 generates transcript 152, and/or operation 626 performs other speech recognition tasks.

FIG. 7 shows a flowchart 700 illustrating exemplary operations that may be performed by architecture 100, specifically architecture 100b. Flowchart 700 follows flowchart 600, although some operations differ and flowchart 700 has additional operation, as noted below. Operations 602-616 proceed as described for flowchart 600. However, in operation 618, acoustic environment profile estimate 144 comprises plurality of acoustic environment parameters 146.

Flowchart 700 adds paths of operations 702-704 and/or operations 706-708, which may be performed in the alternate, or both paths may be executed. Operation 702 selects training data, specifically training data set 206a, for ASR model 150 based on at least acoustic environment profile estimate 144, and operation 704 trains ASR model 150 with the selected training data. Operation 706 generates room profile 204a from plurality of acoustic environment parameters 146, and operation 708 stores room profile 204a among plurality of room profiles 204.

Operation 620 performs ASR using room profile 204a as acoustic environment profile estimate 144 the first pass through, but may use a different room profile on subsequent passes. In flowchart 700, operation 620 comprises operations 710-714. A new audio signal, for example audio signal 110b, is received in operation 710. Operation 712 selects a room profile from among plurality of room profiles 204, and operation 714 provides the selected room profile as an input to ASR model 150. Operations 622-626 proceed as described for flowchart 600.

At some point, users of architecture 100b may wish to determine whether the ASR pipeline is still performing optimally or requires adjustment. A new audio signal containing speech, audio signal 110c, is received in operation 716. Operation 718 extracts spectral features 230 and modulation features 232 from audio signal 110c, similarly as was described for operation 606. Operation 720 combines spectral features 230 and modulation features 232 into combined feature set 236, similarly as was described for operation 612.

Operation 722 compares acoustic characteristics, either by comparing combined feature set 236 with combined feature set 136, or by comparing plurality of acoustic environment parameters 246 with plurality of acoustic environment parameters 146. If the acoustic environment parameters are compared, operation 722 includes a version of operation 618.

Decision operation 724 determines whether to generate a new room profile, based on at least the comparison of operation 722. If a new room profile is not needed, flowchart 700 returns to operation 620, where audio signal 110d is received in operation 710 and ASR continues using room profile 204a as ASR input in operation 714. If, however, a new room profile is needed, flowchart 700 returns to operation 706. This time, operation 706 generates room profile 204b, which is stored in operation 708, and operation 714 performs ASR on audio signal 110d using room profile 204b.

The disclosed deep-learning-based NISA solution performs a joint estimation of a large set of speech signal parameters, including those related to reverberation (C50, DRR, reflection coefficient and room volume), background noise (SNR), perceptual speech quality (PESQ), speech intelligibility (ESTOI), voice activity detection, and speech coding (codec presence and bitrate). The neural embedding-based combination of spectral features with an LSTM and modulation features with a CNN enable NISA to achieve the performance described herein.

Aspects of the disclosure provide solutions with the use of a neural embedding system that encapsulates background acoustics in a compressed form and allows for similarity estimation to be performed. The embeddings may be used to locate similar data from an existing collection or from a pool of simulated data, or guide simulation efforts to generate training data. Acoustic similarity estimation based on an NN framework leverages a feature extraction front-end along with multi-task learning and neural embedding modelling. This allows for the analysis of collected (or simulated) data in terms of the background acoustics and system performance, which for an ASR target, may be WER.

Advantageous aspects of the disclosure encapsulate a large space of acoustic and ASR parameters in a concise neural embedding vector. This neural embedding vector is useable for analyzing collections of data to find similar (or dissimilar) data in terms of the background acoustics. This enhances training dataset construction and selection.

Further aspects of the disclosure provide neural embeddings as an additional input to a single channel ASR (or other speech processing system) thus allowing the speech processing system to learn explicitly about the background acoustics. This is particularly advantageous for single channel ASR, because a multi-channel ASR is typically able to robustly model spatial properties of sound from the multiple microphone signals. Using the neural embedding as an additional input allows single channel ASR to be more robust and thus more accurate.

For example, in a distant speech recognition scenario, in which there is a significant distance between speaker 102a or 102b and microphone 106, knowing the level of reverberation in an utterance affects ASR. Additionally, identifying that acoustic environment parameters in acoustic environment 108, during operation of architecture 100 (e.g., during transcription of a conversation between speakers 102a and 102b) are different than the acoustic environment parameters in the training data, provides an indication that either new training or adaption is needed. The ability to proactively detect such scenarios and take mitigating actions is one of multiple benefits of the disclosure.

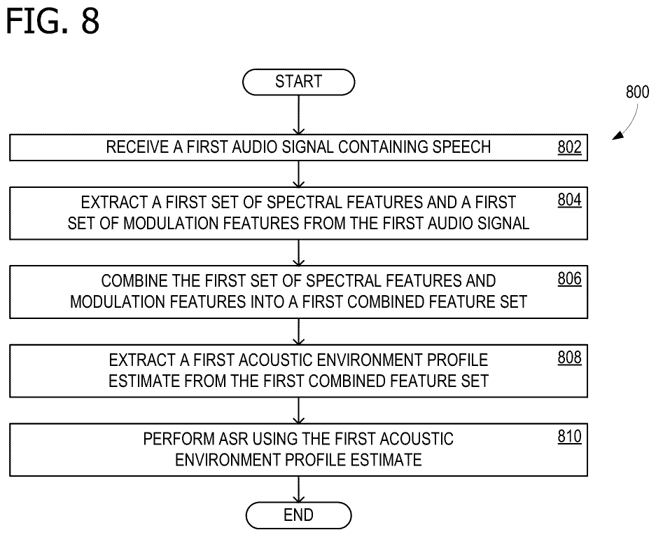

FIG. 8 shows a flowchart 800 illustrating exemplary operations that may be performed by architecture 100. In some examples, operations described for flowchart 800 are performed by computing device 900 of FIG. 9. Flowchart 800 commences with operation 802, which includes receiving a first audio signal containing speech.

Operation 804 includes extracting a first set of spectral features and a first set of modulation features from the first audio signal. Operation 806 includes combining the first sets of spectral features and modulation features into a first combined feature set. Operation 808 includes extracting a first acoustic environment profile estimate from the first combined feature set. Operation 810 includes performing ASR using the first acoustic environment profile estimate.

### ADDITIONAL EXAMPLES

An example system comprises: a processor; and a computer-readable medium storing instructions that are operative upon execution by the processor to: receive a first audio signal containing speech; extract a first set of spectral features and a first set of modulation features from the first audio signal; combine the first sets of spectral features and modulation features into a first combined feature set; extract a first acoustic environment profile estimate from the first combined feature set; and perform ASR using the first acoustic environment profile estimate.

An example computerized method comprises: receiving a first audio signal containing speech; extracting a first set of spectral features and a first set of modulation features from the first audio signal; combining the first sets of spectral features and modulation features into a first combined feature set; extracting a first acoustic environment profile estimate from the first combined feature set; and performing ASR using the first acoustic environment profile estimate; and generating a transcript from the ASR.

One or more example computer storage devices have computer-executable instructions stored thereon, which, on execution by a computer, cause the computer to perform operations comprising: receiving a first audio signal containing speech; extracting a first set of spectral features and a first set of modulation features from the first audio signal, wherein extracting the first set of spectral features comprises determining MFB coefficients from the first audio signal, and wherein extracting the first set of modulation features comprises applying successive Fourier transforms to audio frames of the first audio signal; combining the first sets of spectral features and modulation features into a first combined feature set; extracting a first acoustic environment profile estimate from the first combined feature set; and performing ASR using the first acoustic environment profile estimate; and generating a transcript from the ASR.

Alternatively, or in addition to the other examples described herein, examples include any combination of the following:
the first acoustic environment profile estimate comprises a first plurality of acoustic environment parameters;
generating a first room profile from the first plurality of acoustic environment parameters;
receiving a second audio signal containing speech;
performing ASR on the second audio signal using the first room profile as an input to the ASR;
receiving a third audio signal containing speech;
extracting a second set of spectral features and modulation features from the third audio signal;
combining the second sets of spectral features and modulation features into a second combined feature set;
determining whether to generate a second room profile;
comparing the second combined feature set with the first combined feature set;
based on comparing the second combined feature set with the first combined feature set, determining whether to generate a second room profile;
comparing the second plurality of acoustic environment parameters with the first plurality of acoustic environment parameter;
based on comparing the second plurality of acoustic environment parameters with the first plurality of acoustic environment parameters, determining whether to generate a second room profile;
based on determining to generate the second room profile, generating the second room profile from the second plurality of acoustic environment parameters;
receiving a fourth audio signal containing speech;
performing ASR on the fourth audio signal using the second room profile as an input to the ASR;
the first plurality of acoustic environment parameters includes two or more parameters selected from the list consisting of: SNR, SSNR, clarity index (C50), reverberation, RT, DRR, room volume, reflection coefficients, RIR, voice activity, codec information, bit rate, speech quality, intelligibility, and perceptual quality;
the first acoustic environment profile estimate comprises an acoustic embedding vector;
performing ASR on the first audio signal using the acoustic embedding vector as an input to the ASR;
combining the spectral features and modulation features into the combined feature set comprises performing gated concatenation of the spectral features and modulation features;
determining MFB coefficients from the first audio signal;
applying successive Fourier transforms to audio frames of the first audio signal;
combining the spectral features and modulation features into the combined feature set comprises performing direct concatenation of the spectral features and modulation features;
segmenting the first, second, third, and/or fourth audio signal into a plurality of overlapping audio frames;
storing the first room profile among a plurality of room profiles;
storing the second room profile among the plurality of room profiles;
prior to performing ASR, selecting a room profile from among the plurality of room profiles;
selecting training data for an ASR model based on at least the first acoustic environment profile estimate;
training the ASR model with the selected training data;
using an NN to extract the acoustic environment profile estimate from the combined feature set;
the NN comprises a DNN;
the NN comprises an RNN;
the NN comprises an LSTM network;
the NN comprises a CNN;
performing speaker diarization; and
extracting a first set of spectral features and a first set of modulation features using NISA.

While the aspects of the disclosure have been described in terms of various examples with their associated operations, a person skilled in the art would appreciate that a combination of operations from any number of different examples is also within scope of the aspects of the disclosure.

### Example Operating Environment

FIG. 9 is a block diagram of an example computing device 900 (e.g., a computer storage device) for implementing aspects disclosed herein, and is designated generally as computing device 900. In some examples, one or more computing devices 900 are provided for an on-premises computing solution. In some examples, one or more computing devices 900 are provided as a cloud computing solution. In some examples, a combination of on-premises and cloud computing solutions are used. Computing device 900 is but one example of a suitable computing environment and is not intended to suggest any limitation as to the scope of use or functionality of the examples disclosed herein, whether used singly or as part of a larger set.

Neither should computing device 900 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 900 includes a bus 910 that directly or indirectly couples the following devices: computer storage memory 912, one or more processors 914, one or more presentation components 916, input/output (I/O) ports 918, I/O components 920, a power supply 922, and a network component 924. While computing device 900 is depicted as a seemingly single device, multiple computing devices 900 may work together and share the depicted device resources. For example, memory 912 may be distributed across multiple devices, and processor(s) 914 may be housed with different devices.

Bus 910 represents what may be one or more busses (such as an address bus, data bus, or a combination thereof). Although the various blocks of FIG. 9 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 9 and the references herein to a “computing device.” Memory 912 may take the form of the computer storage media referenced below and operatively provide storage of computer-readable instructions, data structures, program modules and other data for the computing device 900. In some examples, memory 912 stores one or more of an operating system, a universal application platform, or other program modules and program data. Memory 912 is thus able to store and access data 912a and instructions 912b that are executable by processor 914 and configured to carry out the various operations disclosed herein.

In some examples, memory 912 includes computer storage media. Memory 912 may include any quantity of memory associated with or accessible by the computing device 900. Memory 912 may be internal to the computing device 900 (as shown in FIG. 9), external to the computing device 900 (not shown), or both (not shown). Additionally, or alternatively, the memory 912 may be distributed across multiple computing devices 900, for example, in a virtualized environment in which instruction processing is carried out on multiple computing devices 900. For the purposes of this disclosure, “computer storage media,” “computer-storage memory,” “memory,” and “memory devices” are synonymous terms for memory 912, and none of these terms include carrier waves or propagating signaling.

Processor(s) 914 may include any quantity of processing units that read data from various entities, such as memory 912 or I/O components 920. Specifically, processor(s) 914 are programmed to execute computer-executable instructions for implementing aspects of the disclosure. The instructions may be performed by the processor, by multiple processors within the computing device 900, or by a processor external to the client computing device 900. In some examples, the processor(s) 914 are programmed to execute instructions such as those illustrated in the flow charts discussed below and depicted in the accompanying drawings. Moreover, in some examples, the processor(s) 914 represent an implementation of analog techniques to perform the operations described herein. For example, the operations may be performed by an analog client computing device 900 and/or a digital client computing device 900. Presentation component(s) 916 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 900, across a wired connection, or in other ways. I/O ports 918 allow computing device 900 to be logically coupled to other devices including I/O components 920, some of which may be built in. Example I/O components 920 include, for example but without limitation, a microphone, joystick, game pad, satellite dish, scanner, printer, wireless device, etc.

Computing device 900 may operate in a networked environment via the network component 924 using logical connections to one or more remote computers. In some examples, the network component 924 includes a network interface card and/or computer-executable instructions (e.g., a driver) for operating the network interface card. Communication between the computing device 900 and other devices may occur using any protocol or mechanism over any wired or wireless connection. In some examples, network component 924 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 924 communicates over wireless communication link 926 and/or a wired communication link 926a to a remote resource 928 (e.g., a cloud resource) across network 930. Various different examples of communication links 926 and 926a include a wireless connection, a wired connection, and/or a dedicated link, and in some examples, at least a portion is routed through the internet.

Although described in connection with an example computing device 900, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a computer-readable medium storing instructions that are operative upon execution by the processor to:
receive a first audio signal containing speech;
extract a first set of spectral features and a first set of modulation features from the first audio signal;
combine the first set of spectral features and the first set of modulation features into a first combined feature set;
extract a first acoustic environment profile estimate from the first combined feature set; and
perform automatic speech recognition (ASR) using the first acoustic environment profile estimate.

2. The system of claim 1,
wherein the first acoustic environment profile estimate comprises a first plurality of acoustic environment parameters;
wherein the instructions are further operative to:
generate a first environment profile from the first plurality of acoustic environment parameters; and
wherein performing ASR using the first acoustic environment profile estimate comprises:
receiving a second audio signal containing speech; and
performing ASR on the second audio signal using the first environment profile as an input to the ASR.

3. The system of claim 2, wherein the instructions are further operative to:
receive a third audio signal containing speech;
extract a second set of spectral features and a second set of modulation features from the third audio signal;
combine the second set of spectral features and the second set of modulation features into a second combined feature set;
determine whether to generate a second environment profile;
based on determining to generate the second environment profile, generate a second environment profile from the second plurality of acoustic environment parameters;
receive a fourth audio signal containing speech; and
perform ASR on the fourth audio signal using the second environment profile as an input to the ASR.

4. The system of claim 1,
wherein the first acoustic environment profile estimate comprises an acoustic embedding vector; and
wherein performing ASR using the first acoustic environment profile estimate comprises:
performing ASR on the first audio signal using the acoustic embedding vector as an input to the ASR.

5. The system of claim 1, wherein combining the spectral features and modulation features into the combined feature set comprises:
performing gated concatenation of the spectral features and modulation features.

6. The system of claim 1, wherein extracting the first set of spectral features comprises:
determining Mel filter bank (MFB) coefficients from the first audio signal.

7. The system of claim 1, wherein extracting the first set of modulation features comprises:
applying successive Fourier transforms to audio frames of the first audio signal.

8. A computerized method comprising:
receiving a first audio signal containing speech;
extracting a first set of spectral features and a first set of modulation features from the first audio signal;
combining the first set of spectral features and the first set of modulation features into a first combined feature set;
extracting a first acoustic environment profile estimate from the first combined feature set;
performing automatic speech recognition (ASR) using the first acoustic environment profile estimate; and
generating a transcript from the ASR.

9. The computerized method of claim 8,
wherein the first acoustic environment profile estimate comprises a first plurality of acoustic environment parameters;
wherein the method further comprises:
generating a first environment profile from the first plurality of acoustic environment parameters; and
wherein performing ASR using the first acoustic environment profile estimate comprises:
receiving a second audio signal containing speech; and
performing ASR on the second audio signal using the first environment profile as an input to the ASR.

10. The computerized method of claim 9, further comprising:
receiving a third audio signal containing speech;
extracting a second set of spectral features and a second set of modulation features from the third audio signal;
combining the second set of spectral features and the second set of modulation features into a second combined feature set;
determining whether to generate a second environment profile;
based on determining to generate the second environment profile, generating a second environment profile from the second plurality of acoustic environment parameters;
receiving a fourth audio signal containing speech; and
performing ASR on the fourth audio signal using the second environment profile as an input to the ASR.

11. The computerized method of claim 9, wherein the first plurality of acoustic environment parameters includes two or more parameters selected from the list consisting of:
signal to noise ratio (SNR), segmental SNR (SSNR), clarity index, reverberation, reverberation time, direct-to-reverberant energy ratio (DRR), room volume, reflection coefficients, room impulse response (RIR), voice activity, codec information, bit rate, speech quality, intelligibility, and perceptual quality.

12. The computerized method of claim 8,
wherein the first acoustic environment profile estimate comprises an acoustic embedding vector; and
wherein performing ASR using the first acoustic environment profile estimate comprises:
performing ASR on the first audio signal using the acoustic embedding vector as an input to the ASR.

13. The computerized method of claim 8, wherein combining the spectral features and modulation features into the combined feature set comprises:
performing gated concatenation of the spectral features and modulation features.

14. The computerized method of claim 8, wherein extracting the first set of spectral features comprises:
determining Mel filter bank (MFB) coefficients from the first audio signal.

15. The computerized method of claim 8, wherein extracting the first set of modulation features comprises:
applying successive Fourier transforms to audio frames of the first audio signal.

16. One or more computer storage devices having computer-executable instructions stored thereon, which, on execution by a computer, cause the computer to perform operations comprising:
receiving a first audio signal containing speech;
extracting a first set of spectral features and a first set of modulation features from the first audio signal, wherein extracting the first set of spectral features comprises determining Mel filter bank (MFB) coefficients from the first audio signal, and wherein extracting the first set of modulation features comprises applying successive Fourier transforms to audio frames of the first audio signal;
combining the first set of spectral features and the first set of modulation features into a first combined feature set;
extracting a first acoustic environment profile estimate from the first combined feature set;
performing automatic speech recognition (ASR) using the first acoustic environment profile estimate; and
generating a transcript from the ASR.

17. The one or more computer storage devices of claim 16,
wherein the first acoustic environment profile estimate comprises a first plurality of acoustic environment parameters;
wherein the operations further comprise:
generating a first environment profile from the first plurality of acoustic environment parameters; and
storing the first environment profile among a plurality of environment profiles;
wherein performing ASR using the first acoustic environment profile estimate comprises:
receiving a second audio signal containing speech; and
performing ASR on the second audio signal using the first environment profile as an input to the ASR.

18. The one or more computer storage devices of claim 17, wherein the operations further comprise:
receiving a third audio signal containing speech;
extracting a second set of spectral features and a second set of modulation features from the third audio signal;
combining the second set of spectral features and the second set of modulation features into a second combined feature set;
determining whether to generate a second environment profile;
based on determining to generate the second environment profile, generating a second environment profile from the second plurality of acoustic environment parameters;
storing the storing the second environment profile among the plurality of environment profiles;
receiving a fourth audio signal containing speech;
prior to performing ASR, selecting the second environment profile from among the plurality of environment profiles; and
performing ASR on the fourth audio signal using the second environment profile as an input to the ASR.

19. The one or more computer storage devices of claim 16,
wherein the first acoustic environment profile estimate comprises an acoustic embedding vector; and
wherein performing ASR using the first acoustic environment profile estimate comprises:
performing ASR on the first audio signal using the acoustic embedding vector as an input to the ASR.

20. The one or more computer storage devices of claim 16, wherein combining the spectral features and modulation features into the combined feature set comprises:
performing gated concatenation of the spectral features and modulation features.
